(19) United States
(12) Patent Application Publication
(10) Pub. No.: US 2006/0219696 A1
(43) Pub. Date: Oct. 5, 2006

(54) Method for detecting the inclined status of hot plate

(76) Inventor: Ming-Jen Cheng, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/098,493

(22) Filed: Apr. 5, 2005

(51) Int. Cl. H05B 3/68

(52) U.S. Cl. 219/444.1

(57) ABSTRACT

A method for detecting the inclined status of a hot plate comprising selecting a sensitive photoresist coated on a wafer. A first wafer is positioned on a standard hot plate to perform a bake treatment. A stepping exposure with gradually changing light intensity is performed to obtain the minimum exposure energy of the thickness of the first photoresist layer. A second photoresist layer the same as the first wafer is coated on the surface of the second wafer, and positioned on a hot plate under test to perform a bake treatment. The second photoresist layer is exposed by a minimum exposure energy, thereby having the first photoresist layer being uniformly exposed or not to determine whether the hot plate under test is inclined or not.

### BACKGROUND OF THE INVENTION

1. Field of the Invention

The present invention relates to a method for detecting the inclined status of a hot plate, and more particularly, to a method for detecting the inclined status of a hot plate by using the threshold energy of the photoresist agent.

2. Description of the Prior Art

Lithography processing typically includes one or more baking steps both before (pre-exposure bake) and after (post-exposure bake) the exposure step. The wafer is typically placed on or proximate to a hot plate, which includes several (often up to ten) individual heating elements for producing heat at different regions of the hot plate.

The hot plate conducts the heat to the wafer thereon, thereby moving the solution of the photoresist agent on the wafer toward the heated surface, or reorganizing the photoresist structure after the exposure, in order to reduce a standing-wave effect generated by the exposure source using the light. Therefore, the time and the temperature in the operation are very important conditions. These conditions are based on the uniformly thickness. The important factor in regards to these conditions is whether the hot plate is inclined or not.

The conventional method for detecting if the hot plate is inclined uses the measure of thin film thickness to determine if the hot plate is inclined. However, the conventional process requires too much time. Therefore, the present invention provides a method for detecting the inclined status of a hot plate, which reduces the time of detecting the hot plate and reduces the measuring process.

### SUMMARY OF THE INVENTION

The present invention provides a method for detecting the inclined status of a hot plate, which simplifies the conventional steps of detecting whether the hot plate is inclined or not.

The present invention also provides a method for detecting the inclined status of a hot plate, which rapidly determines whether the hot plate is inclined or not.

The present invention also provides a method for detecting the inclined status of a hot plate, which quickly finishes the entire step of detecting whether the hot plate is inclined or not in an automatic process.

According to an embodiment of the present invention, a method for detecting the inclined status of a hot plate is provided, comprising the following steps: providing a first wafer; coating a photoresist layer on the surface of the first wafer, and then positioning the first wafer on the hot plate under test to perform a bake treatment; performing an exposure on the first photoresist layer by an exposure threshold energy of the thickness of the first photoresist layer, thereby having the first photoresist layer being uniformly exposed and determine whether the hot plate under test is inclined or not.

These and other objectives of the present invention will become obvious to those of ordinary skill in the art after reading the following detailed description of the preferred embodiment.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a top view showing an exposure status in which an exposure is performed on the photoresist layer by an exposure threshold energy using a second wafer according to the present invention; and

FIG. 2 is a top view showing an exposure is performed on the photoresist layer by an exposure threshold energy using the first wafer to form a uniformly exposed portion of the photoresist layer when the hot plate under test is inclined according to the present invention.

### DETAILED DESCRIPTION OF THE PREFERRED EMBODIMENTS

The present invention provides a method for detecting the inclined status of a hot plate, in which the characteristic of the photoresist layer is used to detect the inclined status of hot plate in the semiconductor process. Accordingly, various modifications and changes may be made without departing from the spirit and scope of the present invention, for example, the exposure method, and the changing method of the exposure energy or the pre-treatment before the exposure.

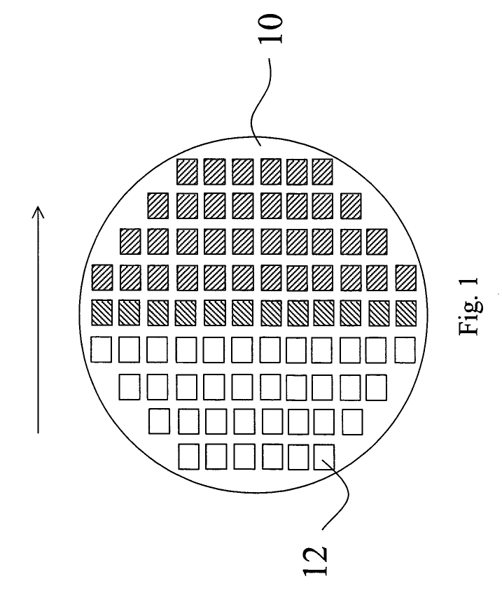

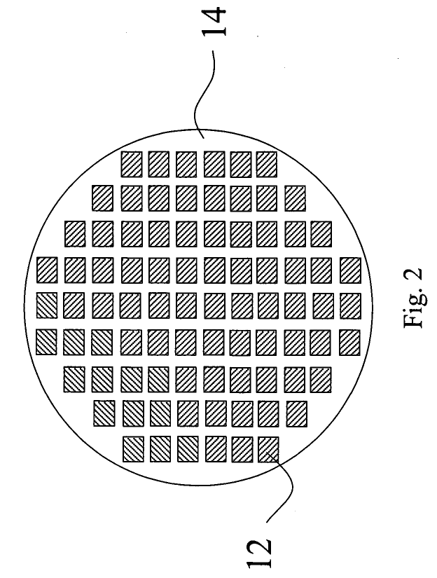

Refer to FIG. 1, which is a top view showing an exposure status in which an exposure is performed on the photoresist layer by an exposure threshold energy using a second wafer according to the present invention and to FIG. 2, which is a top view showing an exposure is performed on the photoresist layer by an exposure threshold energy using the first wafer to form a uniformly exposed portion of the photoresist layer when the hot plate under test is inclined according to the present invention.

Initially, a second wafer 10 is provided after having performed the dehydration bake treatment and the priming treatment. The dehydration bake treatment and the priming treatment are used to form a photoresist layer 12 having uniform thickness and high adhesion ability without any defects on the surface of the second wafer 10. The second wafer 10 is a monitor wafer. A high-sensitivity photoresist with a specific thickness is then covered on the surface of the second wafer 10. The second wafer 10 is positioned on a standard hot plate to perform a bake treatment. A stepping exposure is performed on the photoresist layer 12. The light intensity is changed as the exposure. For example, a movement is chosen as a standard manner, when the exposure apparatus uses a weak light intensity to finish the first line, the light intensity is increased to perform the next line. Repeatedly, the required threshold energy of the exposed photoresist layer is obtained.

As shown in FIG. 1, the arrow direction represents that the light intensity is gradually increased. The exposed status of the photoresist layer is represented by the oblique-line portions and the arrow direction. The non-oblique-line portion represents that the photoresist layer 12 is unexposed due to insufficient exposure energy. The oblique-line portions, which are presented from the left-upper corner to the right-lower corner, represent that the photoresist layer 12 begins to be exposed, that is, the exposure energy is the threshold energy under the thickness of the photoresist layer 12. The oblique-line portions, which are presented from the right-lower corner to the left-upper corner, represent that the photoresist layer 12 has been completely exposed.

Next, a first wafer 14 is selected. The status and the treatment of the first wafer 14, such as the dehydration bake treatment and the priming treatment, are in the same way as the second wafer 20 to control the variable conditions. A second photoresist layer having the same thickness as the first photoresist layer is coated. The first wafer 14 is then positioned on the hot plate under test to be exposed by the required threshold energy of the exposed photoresist layer 14. At this time, the exposure is selected from contact mode, proximity mode, and stepping mode, in order to reduce the exposure time from the stepping exposure. The photoresist layer 12 is uniformly exposed or not to determine whether the hot plate under test is inclined or not. When the hot plate is inclined, the performed pre-exposure bake treatment results in generating a non-uniformly exposed portion of the photoresist layer, thereby quickly finishing the entire step of detecting whether the hot plate is inclined or not in an automatic process.

According to the present invention, a method for detecting the inclined status of a hot plate by the threshold energy of the photoresist layer is provided. Compared with the conventional method for detecting by measuring the thickness of photoresist layer, the present invention is used in an automatic system combined with the exposure, the coating, and the lithography, thereby being more effective.

The embodiment above is only intended to illustrate the present invention; it does not, however, to limit the present invention to the specific embodiment. Accordingly, various modifications and changes may be made without departing from the spirit and scope of the present invention as described in the following claims.

What is claimed is:

1. A method for detecting inclined status of a hot plate, comprising:
providing a first wafer;
coating a first photoresist layer on the surface of the first wafer;
positioning the first wafer on a hot plate under test to perform a first bake treatment; and
performing an exposure on the first photoresist layer by an exposure threshold energy of a thickness of the photoresist layer, thereby having the first photoresist layer being uniformly exposed or not to determine whether the hot plate under test is inclined or not.

2. The method for detecting the inclined status of the hot plate of claim 1, wherein before providing the first wafer further comprising measuring the threshold energy of the thickness of the first photoresist layer, wherein a method for measuring the threshold energy of the thickness of the first photoresist layer comprises:
providing a second wafer;
coating a second photoresist layer similar to the first wafer on the surface of the second wafer, wherein the thickness of the second photoresist layer has the same thickness of the first photoresist layer;
positioning the second photoresist layer on a non-inclined standard hot plate to perform a second bake treatment, wherein the condition of the second bake treatment has the same condition of the first bake treatment; and
performing a stepping exposure with gradually changing light intensity on the second photoresist layer to obtain an exposure threshold energy of the thickness of the second photoresist layer.

3. The method for detecting the inclined status of a hot plate of claim 1, wherein the material of the first photoresist layer is a high-sensitivity photoresist.

4. The method for detecting the inclined status of a hot plate of claim 2, wherein the second wafer is a monitor wafer.

5. The method for detecting the inclined status of a hot plate of claim 2, wherein before coating the second photoresist layer on the second wafer, further performing a dehydration bake treatment, and performing a dehydration bake treatment before coating the first photoresist layer.

6. The method for detecting the inclined status of a hot plate of claim 2, wherein before coating the second photoresist layer on the second wafer, further performing a priming treatment, and performing a priming treatment before coating the first photoresist layer.

7. The method for detecting the inclined status of a hot plate of claim 2, wherein the second photoresist layer is coated on the surface of the second wafer by spin coating, and the first photoresist layer is coated on the surface of the first wafer by spin coating.

8. The method for detecting the inclined status of a hot plate of claim 1, wherein the exposure comprises a contact mode, a proximity mode, and a stepping mode.
